(19) United States
(12) Patent Application Publication
(10) Pub. No.: US 2012/0154541 A1
(43) Pub. Date: Jun. 21, 2012

(54) APPARATUS AND METHOD FOR PRODUCING 3D IMAGES

(75) Inventor: Iain Douglas Scott, Edinburgh (GB)

(73) Assignee: STMicroelectronics (Research & Development) Limited, Marlow (GB)

(21) Appl. No.: 13/329,504

(22) Filed: Dec. 19, 2011

(30) Foreign Application Priority Data
Dec. 21, 2010 (GB) 1021571.3

(51) Int. Cl. H04N 13/02

(52) U.S. Cl. 348/46; 348/E13.074

(57) ABSTRACT

A camera module includes a single lens system, a sensor and an image enhancer. The image enhancer is operable to enhance a single image captured by the sensor via the single lens system. The image enhancer performs opto-algorithmic processing to extend the depth of field of the single lens system, a mapping to derive a depth map from the captured single image; and image processing to calculate suitable offsets from the depth map as is required to produce a 3-dimensional image. The calculated offsets are applied to appropriate image channels so as to obtain the 3-dimensional image from the single image capture.

### PRIORITY CLAIM

This application claims priority from Great Britain Application for Patent No. 1021571.3 filed Dec. 21, 2010, the disclosure of which is hereby incorporated by reference.

### TECHNICAL FIELD

The present invention relates to the production of 3D images, and in particular to producing such 3D images at low cost using a single image capture from a single lens group.

### BACKGROUND

Cameras modules for installation in mobile devices (i.e. mobile phone handsets, Portable Digital Assistants (PDAs) and laptop computers) have to be miniaturized further than those used on compact digital still cameras. They also have to meet more stringent environmental specifications and suffer from severe cost pressure. Consequently, such devices tend to comprise single lens systems.

All 3D techniques to date require additional depth information. This can come from either two images captured separately from two offset positions, or a camera system to consist of two lens and/or sensors separated with the camera/phone body. Alternatively the depth information could come from an alternative source, e.g. radar style topographical information. However, current single lens systems do not contain any depth information and thus a 3D image cannot easily be created from a single image.

It is therefore an aim of the present invention to produce a 3D image from a single image capture of a scene taken using a single lens system camera.

### SUMMARY

In a first aspect there is provided a camera module comprising: a single lens system; sensor means; and image enhancing means for enhancing a single image captured by said sensor means via said single lens system, said image enhancing means comprising: opto-algorithmic means for extending the depth of field of the single lens system; mapping means for deriving a depth map from said single image capture; and image processing means for calculating suitable offsets from said depth map as is required to produce a 3-dimensional image; and for applying said calculated offsets to appropriate image channels so as to obtain said 3-dimensional image from said single image capture.

Such a device uses features already inherent to an EDoF camera module for producing a 3D image from a single image capture. Also this technique could potentially be backwards compatible to EDoF products already sold to the public via a phone software update.

Said opto-algorithmic means may comprise a deliberately introduced lens aberration to said single lens system and means for deconvoluting for said lens aberration. Said opto-algorithmic means may be that sold by DxO.

The term “lens group” will be understood to include single lenses or groups of two or more lenses that produce a single image capture from a single viewpoint.

Said mapping means may be operable assign to each pixel a depth value corresponding to a specific range of object distances based upon a comparison of relative sharpness across color channels.

In one embodiment said image processing means is operable to apply the greatest offset is to imaged objects that were furthest away from the camera module when the image was taken. In another alternative embodiment, said image processing means is operable to apply the greatest offset is to the imaged objects nearest the camera module when the image was taken.

The resultant 3-dimensional image may comprise a two color 3-dimensional anaglyph. Said two colors may be red and cyan.

Said image enhancing means may be operable to sharpen and de-noise the image.

Said image processing means may be operable to process the image to visually correct for the application of said offsets.

In a second aspect there is provided a mobile device comprising a camera module of the first aspect of the invention.

The mobile device may be one of a mobile telephone or similar communications device, laptop computer, webcam, digital still camera or camcorder.

In a third aspect there is provided a method of producing a 3-dimensional image from a single image capture obtained from a single lens system; said method comprising: applying an opto-algorithmic technique so as to extending the depth of field of the single lens system; deriving a depth map from said single image capture; calculating suitable offsets from said depth map as is required to produce said 3-dimensional image; and applying said calculated offsets to the appropriate image channels.

Applying said opto-algorithmic technique may comprise the initial step of deliberately introducing a lens aberration to said single lens system and subsequently deconvoluting for said lens aberration.

Said deriving a depth map may be comprise assigning to each pixel a depth value corresponding to a specific range of object distances based upon a comparison of relative sharpness across color channels.

The step of applying said calculated offsets to the appropriate image channels may comprise applying the greatest offset to imaged objects that were furthest away from the camera module when the image was taken; or alternatively, applying the greatest offset to the imaged objects nearest the camera module when the image was taken.

Said method may comprise further processing the image to visually correct for the application of said offsets.

The resultant 3-dimensional image may comprise a two color 3-dimensional anaglyph. Said two colors may be red and cyan.

In a fourth aspect there is provided computer program product comprising a computer program suitable for carrying out any of the methods of the third aspect of the invention, when run on suitable apparatus.

### BRIEF DESCRIPTION OF THE DRAWINGS

The present invention will now be described, by way of example only, with reference to the accompanying drawing, in which:

FIG. 1 is a flowchart illustrating a proposed method according to an embodiment of the invention.

### DETAILED DESCRIPTION OF THE DRAWINGS

It has been known in many different fields to increase the depth of field (DoF) of incoherent optical systems by phase-encode image data. One such wavefront coding (WFC) technique, is described in E. Dowski and T. W. Cathey, “Extended depth of field through wavefront coding,” Appl. Opt. 34, 1859-1866 (1995), the disclosure of which is hereby incorporated by reference.

In this approach, pupil-plane masks are designed to alter, that is to code, the transmitted incoherent wavefront so that the point-spread function (PSF) is almost constant near the focal plane and is highly extended in comparison with the conventional Airy pattern. As a consequence the wavefront coded image is distorted and can be accurately restored with digital processing for a wide range of defocus values. By jointly optimizing the optical coding and digital decoding, it is possible to achieve tolerance to defocus which could not be attained by traditional imaging systems while maintaining their diffraction-limited resolution.

Another computational imaging system and method for extending DoF is described in PCT Application No. WO 2006/095110, which is herein incorporated by reference. In this method specific lens flaws are introduced at lens design level and then leveraged by the means of signal processing to achieve better performance systems.

The specific lens flaws introduced comprise longitudinal chromatic aberrations which cause the three color channels to have different focus and depth of field. The method then cumulates these different depths of field by transporting the sharpness of the channel that is in focus to the other channels. An Extended Depth of Field (EDoF) engine digitally compensates for these so-introduced chromatic aberrations while also increasing the DoF. It receives a stream of mosaic-like image data (with only one color element available in each pixel location) directly from the image sensor and processes it by estimating a depth map, transporting the sharpness across color channel(s) according to the depth map, and (optionally) performing a final image reconstruction similar to that that would be applied for a standard lens. In generating a depth map, each pixel is assigned a depth value corresponding to a specific range of object distances. This can be achieved with a single shot by simply comparing relative sharpness across color channels.

It is proposed to use inherent characteristics of an EDoF lens system as described above to allow an Image Signal Processor (ISP) to extract object distance and produce a 3D image from a single image capture obtained from a single camera lens system. Using a two color 3D anaglyph as the output image ensures no special screen technology is required in either the phone or other external display. The two color 3D anaglyph technique requires the user to view the image through colored glasses, with a different color filter for each eye. It is a well known technique and requires no further description here. The two colors used may be red and cyan, as this is currently the most common in use, but other color schemes do exist and are equally applicable.

An alternative 3D imaging method presents an animated GIF image, sometimes referred to as a “Jiggly” where the user sees two (or more) ‘flicking’ images to give a 3D effect. Other 3D image techniques are available, but they normally require a compatible screen.

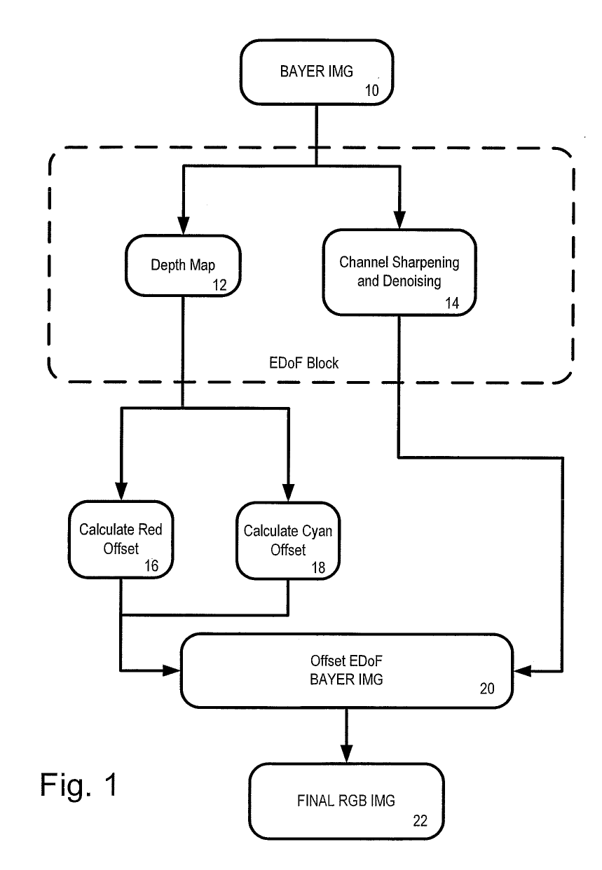

FIG. 1 is a flowchart illustrating a proposed method according to an embodiment. The method comprises the following steps:

Firstly, a Bayer pattern image (IMG) is obtained 10, in the known way. This is the single image capture.

The EDoF engine captures and processes depth information contained within the image and creates a Depth Map 12. In parallel to this, the EDoF engine also applies the ‘normal’ EDoF channel sharpening and denoising to the BAYER pattern image.

Using the information contained in the Depth Map, offsets required to produce the 3D image are calculated 16, 18, such that the greatest offset is applied to objects furthest away, or alternatively, to the objects nearest the camera. The offset is then applied to the appropriate channels 20.

Finally, the image is processed 22 through the normal ISP video pipe to produce the final RGB image. This ISP processing will be required to include fill-in behind the ‘missing’ object to produce a convincing image to the user

As touched upon above, there are two different approaches to the Object Positional Shift calculated at steps 16 and 18. Both methods have their own advantages and disadvantages. The first method comprises offsetting objects that are close to the camera, leaving objects far away, still aligned. This appears to “pop” objects out of the image, but at the cost of the truncation of near objects at the edge of the image. For this reason the second approach (to apply greater positional offset to distant objects) may be the easier option to calculate, and provides a sense of depth to the picture.

It should be noted that the EDoF technology used is required to produce a Depth Map in order to calculate the required positional offsets. While the EDoF system described in PCT Application No. WO 2006/095110 and produced by DxO does utilize a Depth Map, not all EDoF techniques do.

There are several advantages of a being able to create 3D images from a single image capture over that obtained from multiple images, which include:

i) Image registration: Taking two images from two locations relies on the two images overlaying, which can be problematic. This is not an issue for an image obtained from a single capture;

ii) Subject moving: When taking two separate pictures, the subject or objects in the background may have moved during any interval between the two pictures being captured, thus hampering the 3D effect. Again, this is not an issue for an image obtained from a single capture; and

iii) The use of a single camera and single lens system requires less real-estate space in a phone handset (or similar device incorporating the camera).

It should be appreciated that various improvements and modifications can be made to the above disclosed embodiments without departing from the spirit or scope of the invention.

What is claimed is:

1. A camera module comprising:
a single lens system;
an image sensor; and
an image enhancer configured to enhance a single image captured by said image sensor via said single lens system, said image enhancer comprising:
an opto-algorithmic block configured to extend the depth of field of the single lens system;
a mapping block configured to derive a depth map from said captured single image; and
an image processor configured to calculate suitable offsets from said depth map as is required to produce a 3-dimensional image, and configured to apply said calculated offsets to appropriate image channels so as to obtain said 3-dimensional image from said captured single image.

2. The camera module as claimed in claim 1 wherein said opto-algorithmic block is further configured to deliberately introduce a lens aberration to said single lens system and further deconvolute for said lens aberration.

3. The camera module as claimed in claim 1 wherein said mapping block is operable to assign to each pixel a depth value corresponding to a specific range of object distances based upon a comparison of relative sharpness across color channels.

4. The camera module as claimed in claim 1 wherein said image processor is operable to apply a greatest offset to imaged objects that were furthest away from the camera module when the image was taken.

5. The camera module as claimed in claim 4 wherein said image processor is further operable to visually correct for the application of said offsets.

6. The camera module as claimed in claim 1 wherein said image processor is operable to apply a greatest offset is to imaged objects nearest the camera module when the image was taken.

7. The camera module as claimed in claim 6 wherein said image processor is further operable to visually correct for the application of said offsets.

8. The camera module as claimed in claim 1 wherein the resultant 3-dimensional image comprises a two color 3-dimensional anaglyph.

9. The camera module as claimed in claim 8 wherein said two colors are red and cyan.

10. The camera module as claimed in claim 1 wherein the resultant 3-dimensional image comprises an animated GIF image, comprised of at least two quickly alternating images.

11. The camera module as claimed in claim 1 wherein said image enhancer is further operable to sharpen and de-noise the image.

12. The camera module of claim 1 wherein the camera module is a component of a mobile device.

13. The camera module of claim 12 wherein the mobile device is selected from the group consisting of a mobile telephone or similar communications device, laptop computer, webcam, digital still camera or camcorder.

14. A method of producing a 3-dimensional image from a single image captured from a single lens system; said method comprising:
applying an opto-algorithmic technique so as to extend the depth of field of the single lens system;
deriving a depth map from said captured single image;
calculating suitable offsets from said depth map as is required to produce said 3-dimensional image; and
applying said calculated offsets to appropriate image channels.

15. The method as claimed in claim 14 wherein applying said opto-algorithmic technique comprises an initial step of deliberately introducing a lens aberration to said single lens system and a subsequent step of deconvoluting for said lens aberration.

16. The method as claimed in claim 14 wherein said deriving a depth map comprises assigning to each pixel a depth value corresponding to a specific range of object distances based upon a comparison of relative sharpness across color channels.

17. The method as claimed in claim 14 wherein the step of applying said calculated offsets to appropriate image channels comprises applying a greatest offset to imaged objects that were furthest away from the camera module when the image was taken.

18. The method as claimed in claim 17 further comprising the step of processing the image to visually correct for the application of said offset.

19. The method as claimed in claim 14 wherein the step of applying said calculated offsets to appropriate image channels comprises applying a greatest offset to the imaged objects nearest the camera module when the image was taken.

20. The method as claimed in claim 19 further comprising the step of processing the image to visually correct for the application of said offset.

21. A computer program product comprising a computer program suitable for carrying out the following method when run on suitable apparatus, the method comprising:
applying an opto-algorithmic technique so as to extend the depth of field of the single lens system;
deriving a depth map from said captured single image;
calculating suitable offsets from said depth map as is required to produce said 3-dimensional image; and
applying said calculated offsets to appropriate image channels.
